(19) United States
(12) Patent Application Publication
(10) Pub. No.: US 2008/0193275 A1
(43) Pub. Date: Aug. 14, 2008

(54) Electric Machine

(76) Inventors: Pietro De Filippis, Milano (IT); Detlef Kemmer, Altertheim (DE); Harald Redelberger, Kürnach (DE); Hermann Schulz, Kleinlangheim (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/913,601

(22) PCT Filed: Apr. 12, 2006
(86) PCT No.: PCT/EP2006/061538

§ 371 Date: Nov. 5, 2007

(30) Foreign Application Priority Data
May 10, 2005 (EP) 05010167.4

(51) Int. Cl. F01B 25/00; H02K 9/04; H02K 7/14

(52) U.S. Cl. 415/10; 310/43; 310/58

(57) ABSTRACT

An electric machine has a rotor and a stator as well as a method for cooling such a machine. In order to improve cooling of an electric machine, the electric machine (18) has a rotor (2) that is excited by permanent magnets, a stator (38), magnets (3) which are arranged along the circumferential line of the rotor (2) in such a way that a magnetically non-effective zone (10) is created around the center of the rotor (2), at least one opening (11) in the magnetically non-effective zone (10) of the rotor (2) in order to embody an air flow path (41) through the rotor (2), the opening (11) extending substantially in an axial direction, and a fan (15, 56, 58, 59) which moves along with the rotor (2) and is used for embodying an air flow through the opening (11) of the rotor (2).

### CROSS-REFERENCE TO RELATED APPLICATIONS

This application is a U.S. national stage application of International Application No. PCT/EP2006/061538 filed Apr. 12, 2006, which designates the United States of America, and claims priority to European application number 05010167.4 filed May 10, 2005, the contents of which are hereby incorporated by reference in their entirety.

### TECHNICAL FIELD

The invention relates to an electric machine comprising a rotor and a stator. The invention also relates to a fan unit, in particular for a motor vehicle.

### BACKGROUND

Electric machines comprising a rotor and a stator may be used firstly as generators for generating current and secondly as drive motors. For reliable operation of said machines it is necessary to avoid overheating which may lead to a reduction in the service life or to complete failure of the machine. In particular, the electronic units of modern electric motors therefore represent components which are critical from the thermal point of view and thus increase the cooling requirements. In order to divert the heat losses produced, and to control the entire heat balance of such a machine, a plurality of approaches for solving the problem are known, including the use of specific heat sinks or the use of water cooling. Moreover, the use of auxiliary fans arranged on the A-side or B-side is known which results in a marked lengthening of the constructional space.

The European patent application of the applicant with the application number 04 000 739.5-2207 shows an electric machine in which the rotor comprises at least one through ventilation channel to which an air control element is associated, which ensures sufficient supply of air located in the interior of the motor to the through ventilation channel when the rotor is moving. The European patent application with the publication number 0 649 211 A2 discloses an asynchronous machine, the rotor thereof comprising on both sides blade elements for generating a cool air flow. A drawback with the known solutions is that the positioning of through ventilation channels or the like, is always dependent on structural or functional constraints and thus functional drawbacks may not be completely excluded.

### SUMMARY

According to an embodiment, the cooling of an electric machine can be improved by an electric machine and/or by a fan unit comprising a rotor excited by permanent magnets and a stator, magnets in an arrangement on the circumferential line of the rotor such that a magnetically non-effective zone is created around the center of the rotor, at least one opening extending substantially in the axial direction in the magnetically non-effective zone of the rotor for forming an air flow path through the rotor, and a fan moving with the rotor for forming an air flow through the opening of the rotor.

According to a further embodiment, the at least one opening can be configured such that the rotor has substantially the shape of a hollow cylinder, a central fastening element being provided for a rotor shaft which is connected to the rotor by means of struts arranged in the manner of spokes in the opening. According to a further embodiment, the fan and the rotor can be directly connected to one another or form an assembly unit. According to a further embodiment, the fan can be a component of a plastic overmolding of the rotor. According to a further embodiment, the electric machine may further comprise a rear housing part of the machine with at least one air inlet opening, the air inlet opening being arranged at the opening of the rotor, such that the air flowing through the rotor is guided along an electronic component. According to a further embodiment, the electric machine may further comprise a second air flow path guided along the windings of the stator. According to a further embodiment, the fan may be configured as a radial axial fan or as a radial fan or as an axial fan.

### BRIEF DESCRIPTION OF THE DRAWINGS

The present invention is described hereinafter in more detail with reference to an exemplary embodiment which is explained by means of drawings, in which:

FIG. 1 shows the rear face of an embodiment of an open rotor with a fan,

FIG. 2 shows the front face of the open rotor of FIG. 1,

FIG. 3 shows a schematic view of the magnetic flow in the rotor of FIG. 1,

FIG. 4 shows an embodiment of a rear bearing shield of an electric motor,

FIG. 5 shows the open rotor of FIG. 1 fitted onto the rear bearing shield of FIG. 4,

FIG. 6 shows an embodiment of an electric motor with an open rotor and fitted front bearing shield,

FIG. 7 shows a cross section through the electric motor of FIG. 6,

FIG. 8 shows an embodiment of an open rotor with a radial axial fan,

FIG. 9 shows an embodiment of an open rotor with a radial fan,

FIG. 10 shows a further embodiment of an open rotor with an axial fan.

### DETAILED DESCRIPTION

According to an embodiment, the rotational movement of a permanently excited rotor can be used to generate a cool air flow in the electric machine. To this end, the rotor may comprise at least one opening for forming an air flow path through the rotor. According to an embodiment, the at least one opening is arranged in a zone of the rotor which is magnetically non-effective. To this end, the required magnets, preferably in the form of so-called pocket magnets, are arranged on the circumferential line of the rotor such that a magnetically non-effective zone is created around the center of the rotor. The extent of the at least one opening advantageously corresponds to the entire magnetically non-effective zone of the rotor. Due to the rotor material which is not present as a result of the opening, a partially considerable weight reduction of the rotor results having the same performance of the electric machine. The weight reduction according to an embodiment allows the provision of very light-weight electric motors.

According to an embodiment it can be particularly advantageous if the air flow path through the rotor extends substantially in the axial direction, i.e. parallel to the rotor axis, so that the air entering on the rear face of the electric machine is able to pass in the direction of the front face of the electric machine through the rotor. This can be achieved, for example, by the at least one opening in the rotor substantially extending in the axial direction.

In order to move the air flowing through the rotor, a fan can for example be provided which moves with the rotor. The fan draws in the air surrounding said rotor on one side and ejects it on the other side. As a result, a forcibly guided cool air flow is produced by the rotor. In other words, the cool air flow through the rotor contributes to the entire air flow in the electric machine, resulting in improved cooling of the electric machine relative to conventional structures. The improved cooling allows the use of a smaller constructional space with the same performance of the machine and/or increased performance with the same constructional space. At the same time, failure of the electric machine due to overheating is avoided, and as a result of which a long service life is ensured. The use of specific heat sinks or the use of water cooling and/or other costly techniques are not required.

As a result of the fan which moves with the rotor, an air flow assisting the cooling of the machine is achieved, without components moving independently from the rotor being required therefor. The required cooling may, therefore, be provided in a relatively simple manner and thus particularly inexpensively. According to an embodiment, the additional cooling is possible only by slightly lengthening the required constructional space or even without lengthening the required constructional space.

The various embodiments may be used with a plurality of electric machines. According to another embodiment, the electric motor can be used for driving a cooling fan in a motor vehicle.

According to an embodiment, a single opening may be provided such that the rotor has substantially the shape of a hollow cylinder. Thus a fastening element arranged centrally in the remaining rotor “ring” preferably serves for fastening the rotor shaft, and which is connected to the rotor “ring” via struts or the like. In other words, the rotor in this embodiment has a single central opening, in the center of which the fastening element for the rotor shaft is located. The rotor “ring” and the struts arranged in the manner of spokes in the opening can be preferably stamped out of the rotor core and thus also consist of the rotor core lamination material.

In order to allow the fan to move with the rotor, the fan may be preferably connected to the rotor shaft and/or the rotor itself. It may be quite particularly advantageous when the fan and rotor form a structural unit. By such an integral construction, the production and installation cost is markedly reduced. Such a rotor-fan combination may be preferably produced by overmolding the actual rotor with a plastics material. In this connection, preferably the rotor “ring” and the struts may be overmolded at the same time.

It can be quite particularly advantageous if the electric machine is designed such that during operation a constant air flow is formed between an electronic component of the machine and the rotor. As electronic components in modern electric machines from time to time clearly contribute to a large extent to the heating of the machine, the design of such an air flow which may also be formed in the manner of an air film and thus as a type of thermal insulating layer, may contribute considerably to the cooling of the electric machine. Moreover, as a result of the air layer between the motor part and the electronic component, heat transmission from the motor part to the electronic component, which includes the thermally critical elements of the machine, may be prevented.

It can be particularly advantageous in this connection if the electric machine comprises a rear housing part of the machine with at least one air inlet opening. The at least one air inlet opening is advantageously arranged such that there is as little resistance as possible by the machine to the different air flows. The at least one air inlet opening is, moreover, preferably arranged at the at least one opening of the rotor such that the air flowing through the rotor is first guided along the electronic component. If the electronic component is attached in or to the rear housing part of the machine, in order to supply a cool air flow to the electronic component or to guide the cool air flow along said electronic component, the at least one air inlet opening is preferably provided in an outer region of the rear housing part of the machine.

The air movement generated by the fan may result in a flow of cool air from the air inlet opening via the electronic component in the direction of the opening provided centrally in the rotor, heat being carried along by the electronic component. After flowing through the rotor, the cool air is preferably discharged again into the surroundings through at least one air outlet opening in a front housing part of the machine. The rear housing part of the machine and/or the front housing part of the machine are preferably configured as bearing shells for the rotor shaft so that a simple construction is possible.

According to a further embodiment, the fan can be configured as a radial fan. This means that the cool air is drawn in axially, i.e. parallel to the rotor axis and, by the rotation of the fan by 90 degrees, is deflected and radially discharged.

A particularly efficient cooling of the electric machine may be achieved by the electric machine being configured such that a second air flow path is formed to pass along the windings of the stator. If both air flow paths are used for cooling the electric machine, it is advantageous when the fan is configured such that the air flows are influenced as little as possible by the rotor and stator. In particular this can be made possible by the fan being configured as a radial axial fan. In this connection, the cool air which is drawn in is no longer radially discharged by the fan where it comes into direct contact with the cool air discharged by the windings and could lead to undesirable turbulence. Instead, by a deflection of the air, the direction of outflow is altered into an axial direction or an approximately axial direction. The deflection preferably takes place by a corresponding molding of the fan impeller or by air guide plates on the circumference of the fan impeller.

The cooling of the electric machine may be further improved when cooling elements configured according to the rotational direction are provided on at least one housing part. The cooling elements preferably arranged on the rear housing part of the machine serve for the further discharge of heat to the cool air, in particular after the emergence of the cool air from the electric machine. An improved heat discharge to the cool air in comparison with conventional cooling elements is made possible by shaping the cooling elements according to the rotational direction, in particular in the form of air guide blades.

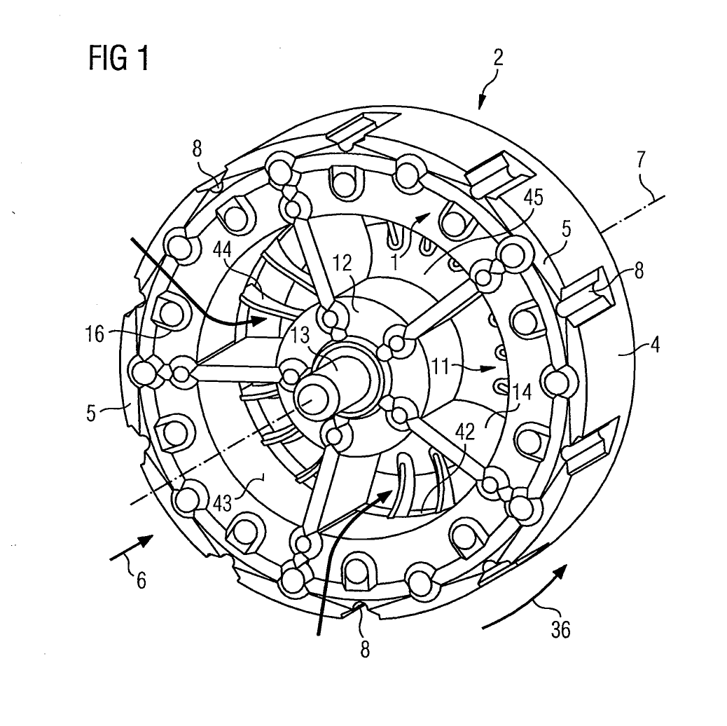

FIG. 1 shows a perspective view of the rear face 1 of a rotor 2 according to an embodiment. The rotor 2 is a permanently excited internal rotor of a brushless electromagnetic direct current motor, as is used in particular as a cooling fan motor in motor vehicles.

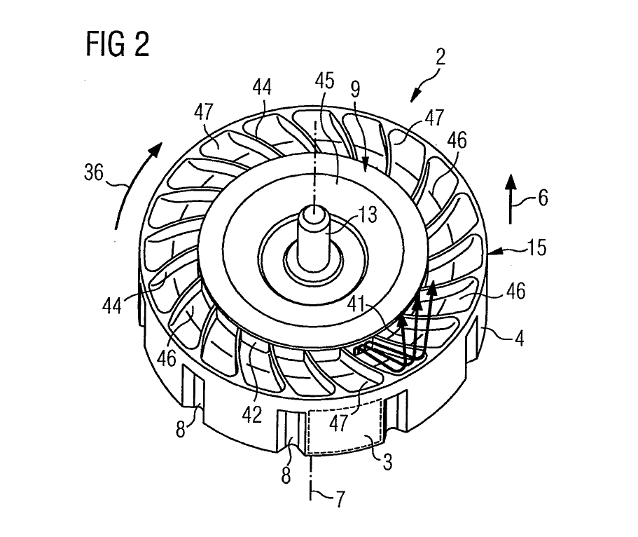

The rotor 2 comprises so-called pocket magnets 3 (in FIG. 2 indicated by dotted lines). The magnets 3 are arranged spaced apart from one another on the circumference 4 of the rotor 2. The magnets 3 are rare earth magnets, for example based on NdFeB. The magnets 3 are enclosed in pockets 5 which are molded into the iron on the circumference 4 of the rotor. For protecting against oxidation the magnets 3 are overmolded with a plastics material. An advantage of magnets embedded in iron in such a manner is that the magnets can only be demagnetized with difficulty even at high currents. Grooves 8 are incorporated between the pockets 5 receiving the magnets 3, and arranged on the circumference 4 of the rotor 2 in the axial direction 6, i.e. parallel to the rotational axis 7 of the rotor 2, which grooves extend from the rear face 1 of the rotor 2 in the direction of the front face 9 of the rotor 2. The grooves 8 are not designed to be continuous but their length corresponds to the length of the pockets 5. The grooves 8 serve, amongst others, to receive conductors flowed-through by current during the magnetizing of the magnets 3 and thus to allow as short a distance as possible from the conductors to the magnets 3 and thus a magnetizing field which is as high as possible. Due to the overmolding of the rotor 2 with plastics material, subsequent magnetizing of the magnets 3 is expedient if the already premagnetized magnets were to lose part of their flux at temperatures associated with the overmolding process.

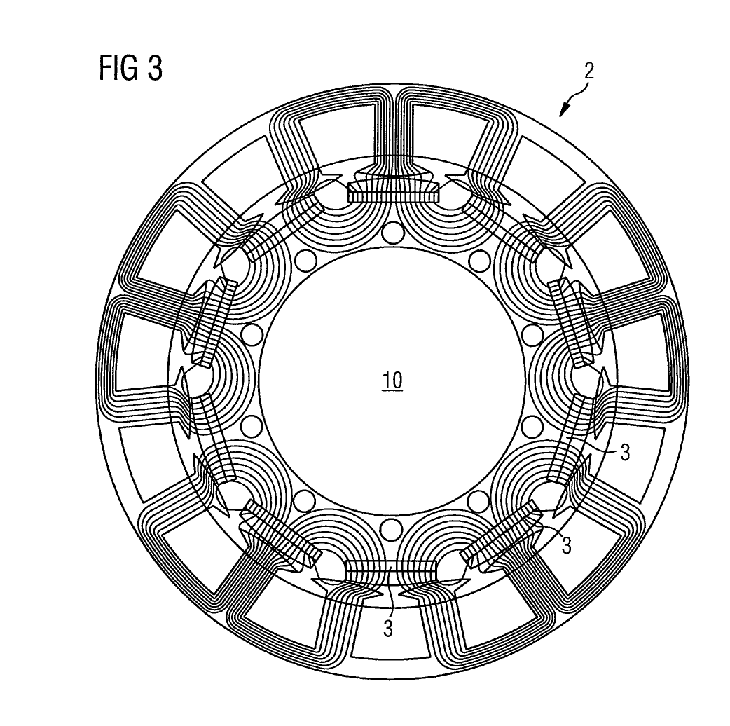

Additionally, by means of this arrangement of the magnets 3 a magnetically non-effective zone 10 is produced in the interior of the rotor 2, see FIG. 3. In other words, the magnetic flux is insignificantly low in this zone or not even present; in any case not absolutely necessary for correct operation of the electric motor. According to an embodiment, the entire magnetically non-effective internal zone 10 of the rotor 2 has been removed, so that the rotor 2 has the shape of a hollow cylinder. The central opening 11 of the rotor produced thereby extends from the rear face 1 of the rotor 2 to the front face 9 of the rotor 2 in the axial direction 6. In the center of the opening 11 a central fastening element 12 is provided for the rotor shaft 13. The fastening element 12 is connected to the rotor 2 via five connecting webs 14 arranged in a star-shaped manner, consisting of the stamped rotor lamination stack.

By removing the iron from the interior 10 of the rotor 2 the weight thereof is markedly reduced. In order to be fixed, the rotor shaft 13 is forced into the fastening element.

A fan 15 made of plastics material is provided on the front face 9 of the rotor 2. According to an embodiment, the fan 15 is produced by the entire rotor 2 being overmolded with plastics material. As a result, not only the magnets 3 but also the core are protected from moisture and environmental conditions. The fan 15 is preferably injection-molded onto the rotor 2 in a single overmolding operation. In other words the fan 15 and rotor 2 form an integral unit, see also FIG. 2, in which said rotor fan unit is shown obliquely from above. The production of this structural unit is thus relatively simple and cost-effective.

During use of an electric motor as a drive for a cooling fan for a motor vehicle, an air flow is already produced by the drive as a result of the pressure difference between the rear face of the electric motor and its output side. Said air flow is further increased by the use of the various embodiments. Naturally the use of the various embodiments, however, is not restricted to cooling fan motors.

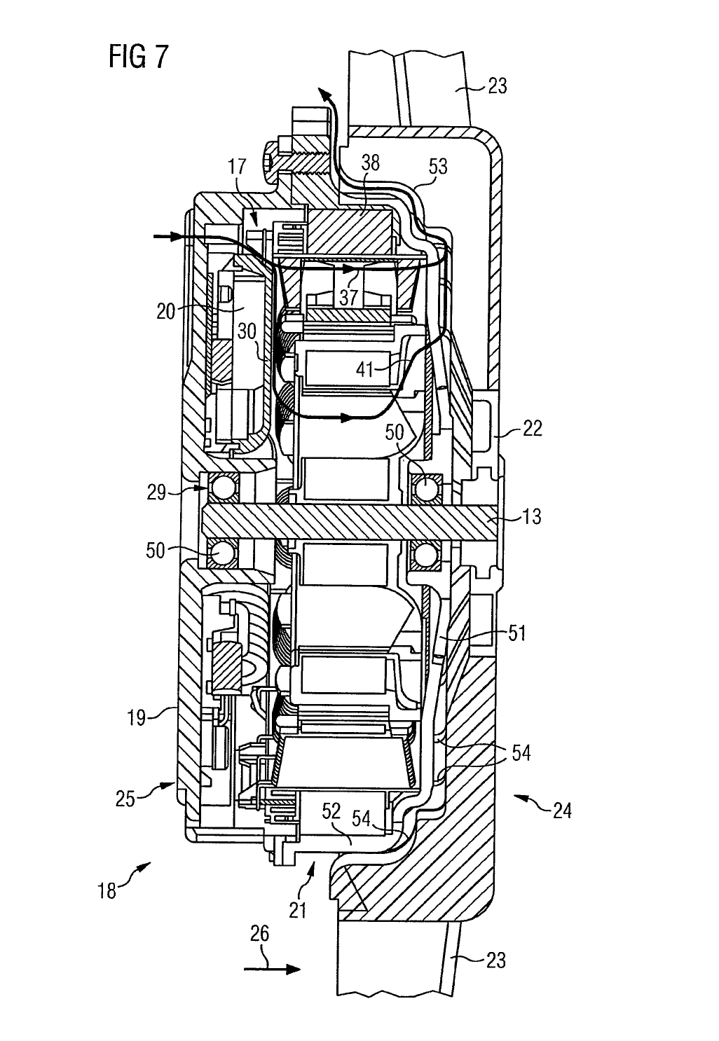

The motor housing of the electric motor 18 enclosing the motor interior 17 consists substantially of a rear bearing cover 19 with integral motor electronics 20 and a housing cover 21 on the output side connected to the bearing cover 19, see FIG. 7. All motor housing parts are designed as aluminum die-cast parts. The use of die-cast parts allows a relatively complicated housing geometry for optimum cooling, as is not possible with the use of conventional stamped bent components or deep-drawn steel housings.

A fan hub 22 with fan blades 23 is positioned on the housing cover 21 on the output side. During operation of the cooling fan the rotating fan blades 23 produce a pressure difference between the front face 24 and the rear face 25 of the electric motor 18, so that an air flow is produced extending in the direction of flow 26. Said air flow is guided as a cool air flow along the motor housing, in order to divert dissipated heat and thus cool the electric motor 18. In contrast to an electric motor with an external rotor, in which the winding and the loss-producing iron are arranged inside, with the internal rotor 2 used in which the winding and the loss-producing iron are arranged outside, the waste heat is to a large extent directly diverted to the motor housing, so that by flowing around the motor housing a portion of the waste heat is already diverted and the motor 18 may be cooled thereby.

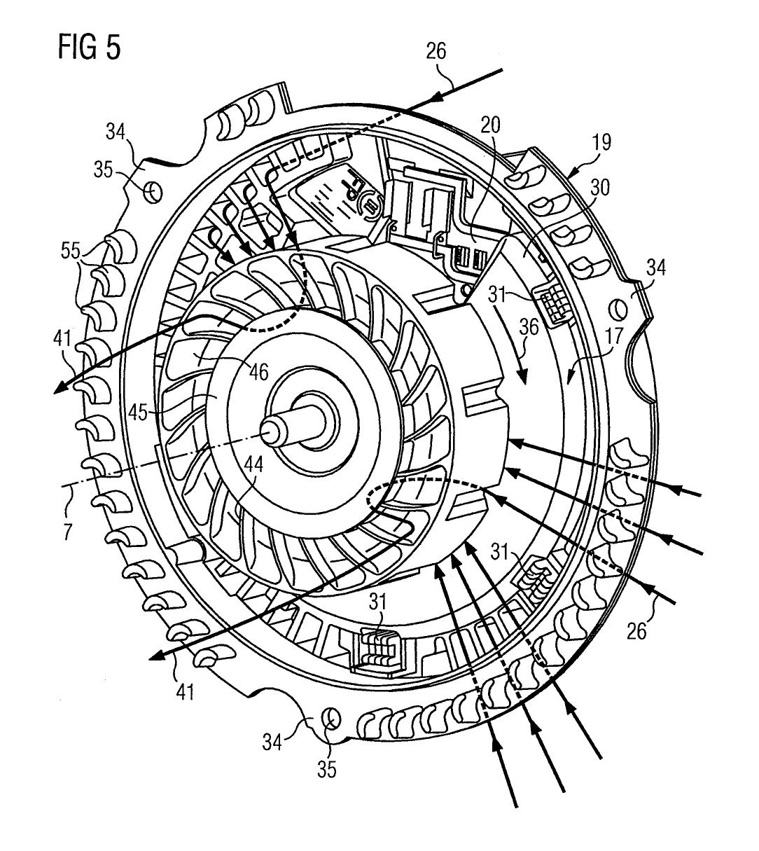

The rear bearing cover 19 consists substantially of a housing ring 27, in which a circular housing trough 28 is arranged. The housing trough 28 comprises in a centered manner the B-side bearing seat 29 of the motor 18, so that the bearing cover 19 simultaneously serves as a rear bearing shield. In the housing trough 28 an electronic module containing the motor electronics 20 is incorporated or connected thereto by means of heat conducting adhesive, see FIG. 5. The electronic module comprises, amongst others, a printed circuit board, not illustrated in detail and a reactor, power transistors, a shunt and electrolytic capacitors. The printed circuit board is thus encapsulated and in particular covered by a cover 30, on the edge of which three phase contacts 31 are exposed, see FIG. 5. The encapsulation firstly serves to protect the enclosed motor electronics 20. The encapsulation also ensures that the dissipated heat generated by the electronics is not diverted into other regions of the electric motor 18, but discharged directly in-situ to the rear housing part 19 and/or the cover 30 and from there is able to be carried along by the various cool air flows. All electronic components are, to this end, connected to the housing trough 28 in a heat conducting manner.

The fan 15 connected fixedly to the rotor 2, and therefore moving with the rotor 2, increases the otherwise present air flow through the motor interior by generating a vacuum. Moreover, the fan 15 assists a flow of cool air through the rotor 2 which has a corresponding opening 11 to this end, after the cool air has already previously passed the motor electronics 20 and has directly absorbed waste heat at that point.

At the junction between the housing trough 28 and the housing ring 27, the housing trough 28 comprises through-holes extending in the direction of flow 26 such that radially extending free-standing cooling ribs 33 are produced, which form air inlet openings 32 therebetween. The cooling ribs 33 simultaneously serve as heat conductors for deflecting the dissipated heat of the motor electronics 20 into the housing ring 27. The air inlet openings 32 serve for the entry of cool air into the motor interior 17 so that the components arranged in the motor interior are directly able to discharge waste heat to the cool air. Flanges 34 comprising mounting surfaces with bores 35 for forming screw connections are attached to the housing ring 27. The bearing cover 19, which comprises corresponding flanges 34′, is connected to the housing cover 21 on the output side via these screw connections.

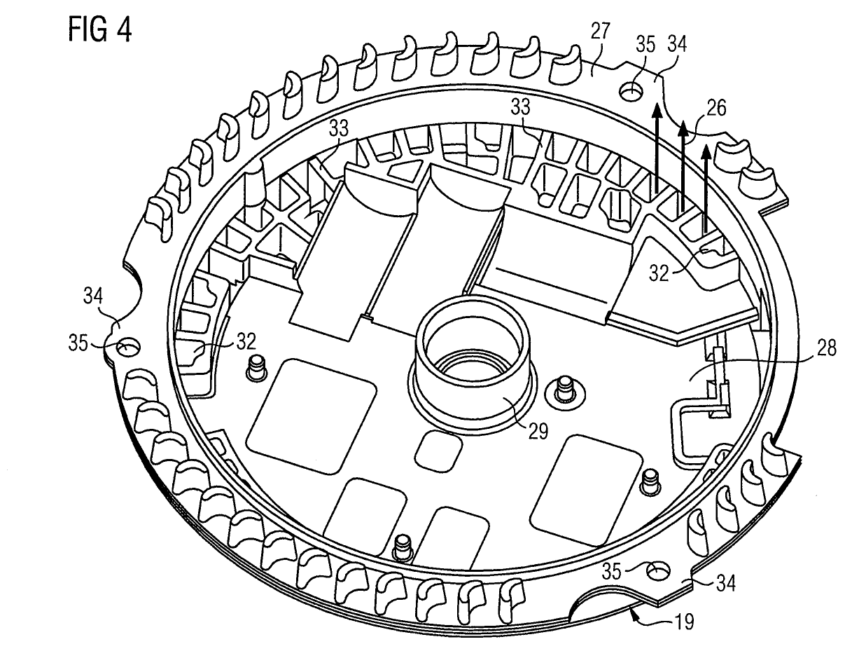

As a result of the general pressure difference between the rear face 25 and the front face 24 of the electric motor 18 due to the rotation of the cooling fan and assisted by the rotation of the rotor 2 in the rotational direction 36, an air supply is therefore produced from outside into the inside of the motor 18 through air inlet openings 32 in the rear-facing bearing shield 19, see FIG. 4. The air inlet openings 32 are therefore arranged in the outer regions of the bearing shield 19, i.e. arranged furthest away from the center point of the rearward bearing shield 19. In contrast to air inlet openings in conventional motors, the air inlet openings 32 are larger in order to ensure sufficient entry of air into the motor interior 17.

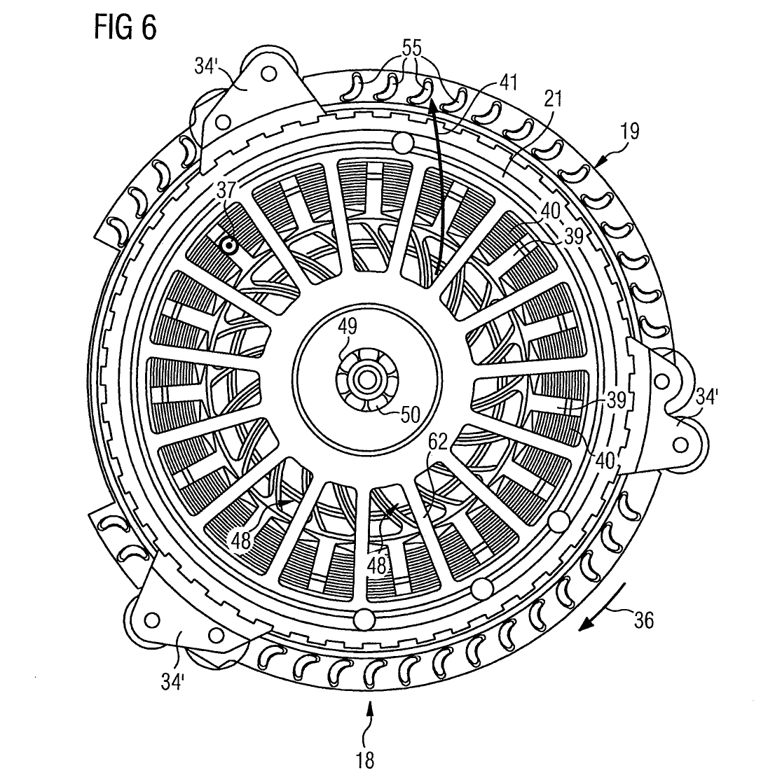

For clarification of the flow path, the air flow paths on the rotor 2 and through the rotor 2 are shown by arrows in the figures. The cool air flow firstly enters through the air inlet openings 32 into the motor interior 17. After the entry into the motor interior 17, the cool air flows on a first flow path 37 through the stator 38, see FIG. 7. To this end, a single tooth winding is provided of the stator teeth spaced apart from one another. The cool air flow is guided through the groove slots 39 and directly past the windings 40, and absorbs the waste heat of the stator core, see also FIG. 6, where the air emerging on the cool air path 37 flows between the windings 40 and flows out of the drawing plane towards the observer. It is particularly advantageous if the position of the air inlet openings 32 as air control openings is adjusted to the position of the stator teeth, such that the cool air flow reaches the copper windings of the stator teeth on a direct path.

Secondly, cool air flows through the rotor 2 on a second flow path 41, such that it firstly blows past the motor electronics 20 integrated in the rear housing cover, in the direction of the bearing 29 and/or rotor shaft 13 and then flows through the rotor 2 through the opening 11, see FIG. 7. In other words, the air entering from outside towards the inside flows towards the opening 11 in the rotor 2 and flows through the rotor 2, see FIG. 1. By the arrangement of the air inlet openings 32 in the bearing cover, during operation a thermally insulating air layer is created between the cover 30 of the motor electronics 20 and the rotor 2. This has the effect, amongst others, that waste heat is prevented from being transferred from the stator 38 to the motor electronics 20 or is at least greatly reduced At the same time, an absorption and removal of waste heat from the motor electronics 20 results from the flow of air.

On the front face 9 of the rotor 2 the air emerges from the rotor 2 through a plurality of outlet openings 42, see FIG. 2. The outlet openings 42 extend as an extension to the internal peripheral surface 43 of the rotor 2 in the direction of the rotor front face 9. They are produced from a type of circumferential air outlet slot which is divided by air conducting webs 44 into individual outlet openings 42. The air conducting webs 44 are arranged on the lower face of a fan hub 45 connected to the fastening element 12. The air conducting webs 44 extend on the front face 9 of the rotor 2 and form the individual fan elements 46 of the fan impeller relative to one another, which extend from the fan hub 45 to the outer circumference 4 of the rotor 2. The fan elements 46 are thus configured as rearwardly curved blades.

The air flowing through the rotor 2 emerges from the air outlet openings 42 and is radially deflected outwards into the fan elements 46. The fan elements 46 are curved on their external ends in the axial direction 6, so that each fan element 46 comprises a type of integrated deflection element 47. By means of the deflection elements 47, the cool air, which flows radially through the fan elements 46, is deflected more or less in the axial direction 6 when leaving the fan element 46. The deflection takes place, however, such that the cool air does not exclusively leave the fan 15 in the radial direction. In other words, after leaving the rotor 2 the cool air is carried along by the fan 15, deflected in the axial direction 6 and discharged from the housing cover 21 on the output side. The housing cover 21 on the output side comprises, to this end, a plurality of through-openings 48, see FIG. 6. The through-openings 48 are arranged in a star-shaped manner about the A-side bearing 49 and form a circular outlet region, which is arranged above the groove slots 39 and the fan elements 46. The support webs 62 separating the through openings 48 from one another are arranged offset to the groove slots 39 such that they extend centrally relative to the windings 40. As a result, the flow resistance against the cool air 37 flowing out of the windings 40 is reduced.

The deflection of the cool air emerging from the rotor 2 in the axial direction 6 causes the two air flows along the flow paths 37, 41, through the stator windings on the one hand and through the rotor 2 on the other hand not to come into contact with one another. This would lead to turbulence in the air flows and thus to an impairment of the cooling performance. In the A-side bearing 49 the rotor shaft 13 is mounted with a ball bearing 50, as in the B side bearing 29. The housing cover 21 thus consists substantially of a cover upper face 51 opposing the housing trough 28 of the bearing cover 19 and a lateral circumferential housing cover wall 52 extending in the axial direction 6, see FIG. 7.

The cool air flows coming from the groove slots 39 and from the fan 15 of the rotor 2, emerge from the motor interior 17 through the through openings 48, and blow over the upper face 51 of the heated housing cover 21, in the direction of flow, absorbing waste heat.

The output-side housing cover 21 is enclosed by the fan hub 22 of the cooling fan in a pot-shaped or bell-shaped manner, so that the cool air flow emerging from the through openings 48, flows over the cover upper face 51 on the output side and emerges through a peripheral air outlet gap 53 on the edge between the motor housing and fan hub 22. The fan hub internal geometry and motor housing parts are thus adjusted in their shape relative to one another such that a relatively narrow air outlet gap 53 between the motor housing and the fan hub 22 is produced at a constant width, so that a high velocity of the cool air passing through may be achieved.

By the rotation of the fan hub 22, the cool air flow when emerging from the relatively narrow air outlet gap 53 is, in other words, additionally accelerated, whereby the pressure difference increases and thus the cooling effect is further improved. The inner face of the fan hub is provided with reinforcing ribs 54 such that said reinforcing ribs serve as fan elements, form a type of radial fan and further accelerate the cool air flow, see FIG. 7. In other words, as a result of the shape of the reinforcing ribs 54 the air flow is increased through the motor interior 17 and thus the cooling effect increased.

The cool air emerging from the air outlet gap 53 comes into contact with the air guide blades 55 arranged on the housing ring 27 of the rear bearing cover 19 and configured according to the direction of rotation, and which are arranged in an annular manner on the circumference of the rear bearing cover 19, see FIG. 6. The air guide blades 55 are also connected in a heat conducting manner to the motor electronics 20, so that they serve to remove the waste heat, which is in particular generated by the motor electronics 20, from the motor interior 17 to the outside. Advantageously, the position of these cooling elements is adjusted to the position of the air outlet gap 53 such that the cool air flow emerging through the air outlet gap 53 reaches the air guide blades 55 on a direct path. As the rotor 2 comprises an integrated fan 15, its rotational direction is fixed. An embodiment of the air guide blades 55 which is selected to correspond to this rotational direction, and which is in particular sickle-shaped, assists a directed flow of the discharged cool air away from the motor 18.

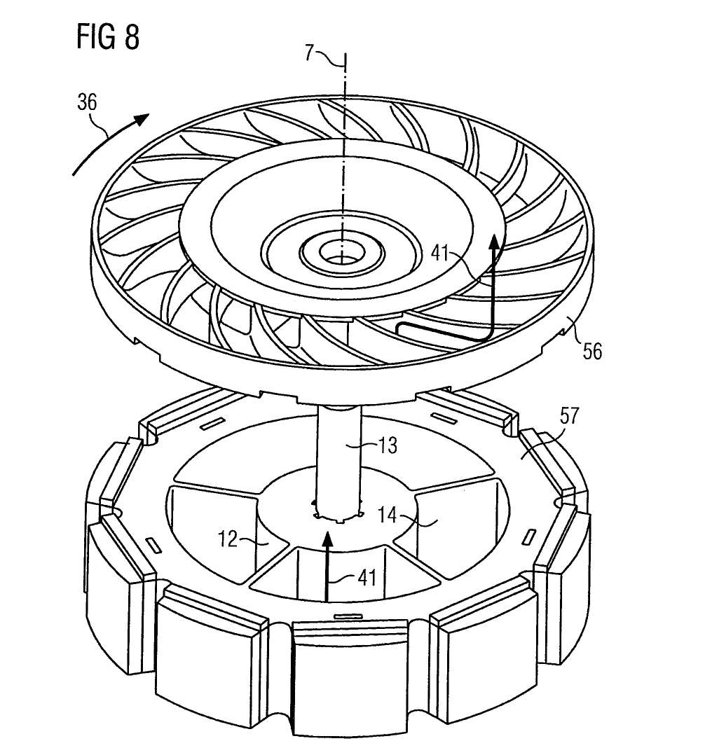

In FIG. 8, an embodiment is provided in which a radial axial fan 56 is also provided for cooperation with an open internal rotor 57. The cool air passing through the rotor 57 is radially accelerated by the fan 56 and then discharged in the axial direction. However, the fan 56 is designed as a separate component which is positioned on the rotor shaft 13 and is connected to the rotor 57 by fastening elements, not shown in detail.

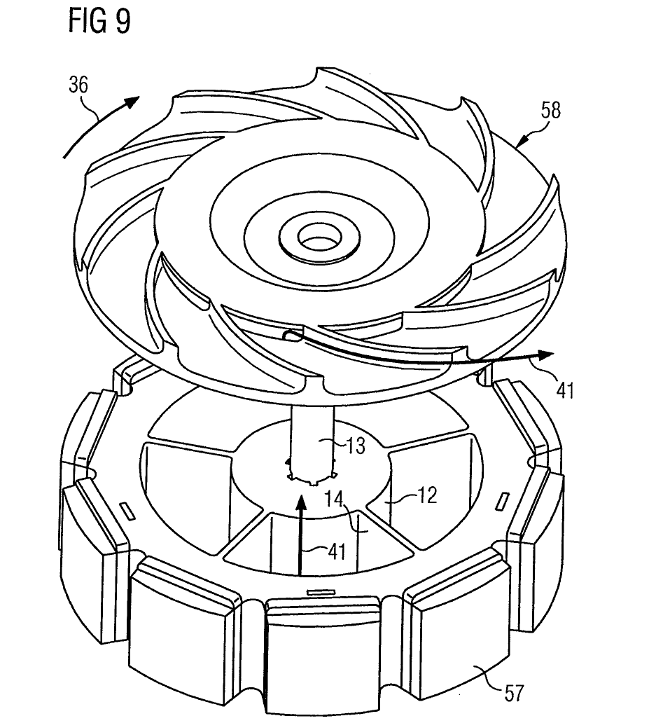

FIG. 9 also shows a separate fan. The fan is simply a radial fan 58 which radially discharges the cool air passing through the rotor 57 to the surroundings.

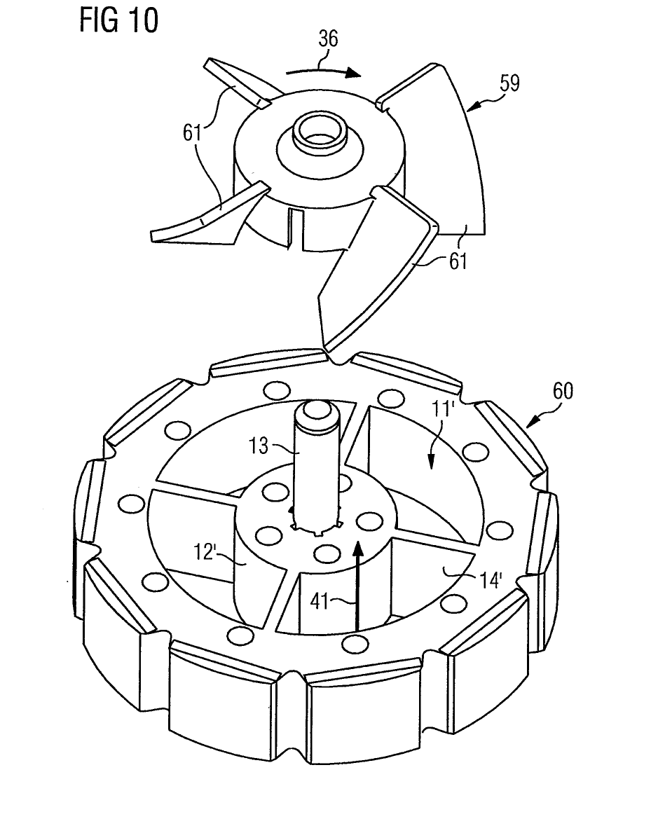

Finally, in FIG. 10 a further embodiment is illustrated, in which a separate fan in the form of an axial fan 59 is provided, which is inserted into the central opening of an internal rotor 60. The connecting elements 14′ between the rotor 60 and the central fastening element 12′ in the opening 11′ are provided such that four open portions are created in which the individual fan elements 61 are arranged in the installed state. This exemplary embodiment is characterized by a particularly flat construction, as the fan 59 is accommodated in the inside of the rotor 60.

What is claimed is:

1. An electric machine, comprising
a rotor excited by permanent magnets and a stator,
magnets in an arrangement on the circumferential line of the rotor such that a magnetically non-effective zone is created around the center of the rotor,
at least one opening extending substantially in the axial direction in the magnetically non-effective zone of the rotor for forming an air flow path through the rotor, and
a fan moving with the rotor for forming an air flow through the opening of the rotor.

2. The electric machine according to claim 1, wherein the at least one opening is configured such that the rotor has substantially the shape of a hollow cylinder, a central fastening element being provided for a rotor shaft which is connected to the rotor by means of struts arranged in the manner of spokes in the opening.

3. The electric machine according to claim 1, wherein the fan and the rotor are directly connected to one another or form an assembly unit.

4. The electric machine according to claim 1, wherein the fan is a component of a plastic overmolding of the rotor.

5. The electric machine according to claim 1, further comprising a rear housing part of the machine with at least one air inlet opening the air inlet opening being arranged at the opening of the rotor, such that the air flowing through the rotor is guided along an electronic component.

6. The electric machine according to claim 1, further comprising a second air flow path guided along the windings of the stator.

7. The electric machine according to claim 1, wherein the fan is configured as a radial axial fan or as a radial fan or as an axial fan.

8. A fan unit comprising a fan driven by an electric machine comprising
a rotor excited by permanent magnets and a stator,
magnets in an arrangement on the circumferential line of the rotor such that a magnetically non-effective zone is created around the center of the rotor,
at least one opening extending substantially in the axial direction in the magnetically non-effective zone of the rotor for forming an air flow path through the rotor, and
wherein the fan is moving with the rotor for forming an air flow through the opening of the rotor.

9. The fan unit according to claim 8, wherein the fan driven by the electric machine is a cooling fan for a motor vehicle.

11. The fan unit according to claim 8, wherein the at least one opening is configured such that the rotor has substantially the shape of a hollow cylinder, a central fastening element being provided for a rotor shaft which is connected to the rotor by means of struts arranged in the manner of spokes in the opening.

12. The fan unit according to claim 8, wherein the fan and the rotor are directly connected to one another or form an assembly unit.

13. The fan unit according to claim 8, wherein the fan is a component of a plastic overmolding of the rotor.

14. The fan unit according to claim 8, further comprising a rear housing part of the machine with at least one air inlet opening, the air inlet opening being arranged at the opening of the rotor, such that the air flowing through the rotor is guided along an electronic component.

15. The fan unit according to claim 8, further comprising a second air flow path guided along the windings of the stator.

16. The fan unit according to claim 8, wherein the fan is configured as a radial axial fan or as a radial fan or as an axial fan.

17. An electric machine, comprising
a rotor,
magnets in an arrangement on the circumferential line of the rotor such that a magnetically non-effective zone is created around the center of the rotor,
at least one opening extending substantially in the axial direction in the magnetically non-effective zone of the rotor for forming an air flow path through the rotor, and
a fan moving with the rotor for forming an air flow through the opening of the rotor, wherein the at least one opening is configured such that the rotor has substantially the shape of a hollow cylinder, a central fastening element being provided for a rotor shaft which is connected to the rotor by means of struts arranged in the manner of spokes in the opening.

18. The electric machine according to claim 17, wherein the fan and the rotor are directly connected to one another or form an assembly unit.

19. The electric machine according to claim 17, wherein the fan is a component of a plastic overmolding of the rotor.

20. The electric machine according to claim 17, further comprising a rear housing part of the machine with at least one air inlet opening, the air inlet opening being arranged at the opening of the rotor, such that the air flowing through the rotor is guided along an electronic component.
